(19) United States
(12) Patent Application Publication
(10) Pub. No.: US 2006/0139447 A1
(43) Pub. Date: Jun. 29, 2006

(54) Eye detection system and method for control of a three-dimensional display

(76) Inventor: Mark A. Unkrich, Redwood City, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/020,948

(22) Filed: Dec. 23, 2004

(51) Int. Cl. H04N 13/04; H04N 15/00; H04N 13/00

(52) U.S. Cl. 348/51; 348/42

(57) ABSTRACT

An autostereoscopic display system includes an autostereoscopic display subsystem operable to display stereoscopic images and to adjust characteristics of the displayed images responsive to detected viewer eye position parameters. An eye detection subsystem detects through differential-angle illumination the eye position of a viewer positioned in front of the display subsystem and generates corresponding viewer eye position parameters. The eye detection subsystem applies the detected viewer eye position parameters the display subsystem to adjust the characteristics of the displayed images.

### BACKGROUND OF THE INVENTION

Three-dimensional display technology has been under development for decades, with various types of three-dimensional display systems having been developed to provide viewers with the perception of depth while actually viewing two-dimensional images. All such three-dimensional display systems exploit the binocular nature of human vision that provides a viewer with the perception of depth derived from small differences in the location of light from an object incident on the left and right retinas of the viewer's eyes. Due to the physical spacing between a person's eyes, each eye has a slightly different viewpoint of the world and of a given point on an object. These different viewpoints result in light from a given point on an object being incident on different locations on the left and right retinas of the viewer's eyes. This difference in locations on the viewer's left and right retinas is known as retinal disparity, and the viewer's brain processes this retinal disparity to give the viewer the sensation of depth.

Three-dimensional display systems exploit the retinal disparity characteristic of human vision to give a viewer the sensation of depth by providing two different images to the viewer's left and right eyes. Each of the two different images is seen by only one of the viewer's eyes, and the resulting disparity between the images creates a retinal disparity that gives the viewer the sensation of depth. Two different cameras record an image from slightly different viewpoints to provide the data corresponding to the two images. Thus, each of the viewer's eyes sees slightly different view of an object and the viewer's brain processes and perceives these different views as depth.

All three-dimensional display systems must somehow provide each of the two images being displayed to only one of the viewer's eyes. The various techniques for doing this define the various types of three-dimensional display systems. One three-dimensional display system that was popular in the 1950's utilized the technique of color multiplexing to provide the two different images to a viewer's respective eyes. In such a system, red and blue images were projected onto a screen and each viewer wore glasses having a red lens for one eye and a blue lens for the other eye. The red and blue lenses function as filters to allow only one image to enter each of a viewer's eyes. The viewer's brain processes the difference between the red and blue images seen by the viewer's respective eyes such that the viewer perceives depth for the objects being displayed in the images. Instead of color multiplexing another conventional system utilizes polarization multiplexing. Two images having different polarizations of light are projected and lenses in glasses worn by each viewer function as polarization filters to allow each eye of the viewer to see only one of the two images. Another conventional system utilizes time multiplexing in which a single camera sequentially shows two images. Viewers wear glasses having lenses that act as shutters to block the view of one eye and then the other in synchronism with the two sequential images being displayed such that each eye sees only one of the two images. Yet another conventional system utilizes spatial multiplexing to provide the perception of depth to a viewer. Viewers each wear a helmet having two tiny displays, each display positioned in front of one of a corresponding one of the viewer's eyes to thereby provide a respective image to each eye.

All the previously described techniques for three-dimensional displays require viewers to wear either special glasses or a special helmet. This is undesirable because it requires special equipment be available and worn by each viewer, which is in contrast to conventional two-dimensional television and movies. As a result, more recent three-dimensional display systems eliminate the need for special glasses or a helmet, and allow a viewer to perceive a three-dimensional image simply when sitting in front of the system. These types of systems are commonly referred to as autostereoscopic systems, with the prior systems requiring glasses or helmets being referred to as stereoscopic display systems.

As with any type of three-dimensional display system, autostereoscopic display systems must provide each eye of a viewer with a different image. This may be done in a variety of different ways. For example, some systems include dual liquid crystal displays (“LCDs”) and appropriate optical components to illuminate each eye of a viewer with an image being displayed on a corresponding one of the LCDs. Other systems utilize a shutter such as a “parallax barrier” positioned in front of a display to show certain pixels of a display to one eye of a viewer and to show other pixels of the display to the other eye of the viewer. With either type of autostereoscopic system, a viewer must be positioned at a particular position or positions in front of the system for proper operation. A particular position is required to ensure each eye of the viewer sees only one of the two images being displayed.

If a viewer is not at the proper position in front of the system, the viewer may not perceive depth or the quality of the image being displayed may be inferior. Moreover, viewers may feel unduly constrained by the limited permissible viewing positions. As a result, various approaches have been utilized to reduce the limitations of viewing positions for viewers. For example, some systems have been developed that allow multiple permissible viewing positions or windows. Other systems have been developed that track head and/or eye positions of a viewer and adjust the characteristics of the display system to properly provide the two images to the viewer's detected head and eye positions. In such tracking systems, however, the detection of viewer eye position can be difficult under variable ambient viewing conditions, such as very low or very high levels of ambient light incident upon the viewer.

There is a need for an autostereoscopic display system that provides accurate and reliable tracking of viewer eye position under varied ambient viewing conditions.

### SUMMARY OF THE INVENTION

According to one aspect of the present invention, an autostereoscopic display system includes an autostereoscopic display subsystem operable to display stereoscopic images and to adjust characteristics of the displayed images responsive to detected viewer eye position parameters. An eye detection subsystem detects through differential-angle illumination the eye position of a viewer positioned in front of the display subsystem and generates corresponding viewer eye position parameters. The eye detection subsystem applies the detected viewer eye position parameters to the display subsystem to adjust the characteristics of the displayed images.

### BRIEF DESCRIPTION OF THE DRAWINGS

FIG. 1 is a functional and perspective view of an autostereoscopic display system that provides accurate and reliable viewer eye detection according to one embodiment of the present invention.

FIG. 2 is top view illustrating in more detail the operation of the parallax barrier display of FIG. 1 in providing dual images to a viewer's eyes positioned within viewing windows in front of the display according to one embodiment of the present invention.

FIG. 3 is a top view illustrating in more detail the parameters of a viewer's eyes determined by the eye detection system of FIG. 1 according to one embodiment of the present invention.

FIG. 4 is a block diagram of a differential-angle illumination eye detection system according to one embodiment of the eye detection system of FIG. 1.

FIG. 5A illustrates an image generated with an on-axis light source contained in the differential-angle illumination eye detection system of FIG. 4.

FIG. 5B illustrates an image generated with an off-axis light source contained in the differential-angle illumination eye detection system of FIG. 4.

FIG. 5C illustrates a differential image resulting from the difference between the images from the on-axis and off-axis light sources of FIGS. 5A and 5B.

### DETAILED DESCRIPTION OF PREFERRED EMBODIMENTS

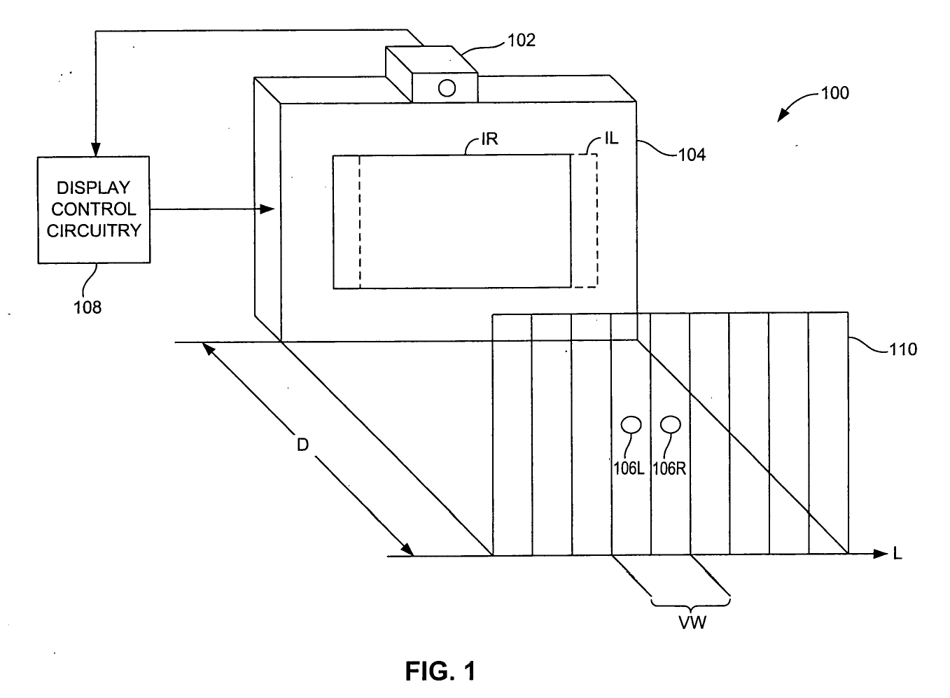

FIG. 1 is a functional and perspective view of an autostereoscopic display system 100 that provides accurate and reliable viewer eye detection according to one embodiment of the present invention. The autostereoscopic display system 100 includes an eye detection system 102 positioned on top of an autostereoscopic display 104. In operation, the eye detection system 102 detects several parameters of a viewer's eyes 106L and 106R positioned within a viewing window VW in front of the display 104. The eye detection system 102 provides the detected eye parameters to display control circuitry 108 which, in response to the detected eye parameters, adjusts the characteristics of left and right images IL and IR displayed on the display 104 to properly provide these images to the eyes 106L and 106R of the viewer within the viewing window VW, as will be described in more detail below.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail below to avoid unnecessarily obscuring the present invention. Also note that in the following description features and components of the system 100 that are the same in multiple figures may be described using the same reference numerals.

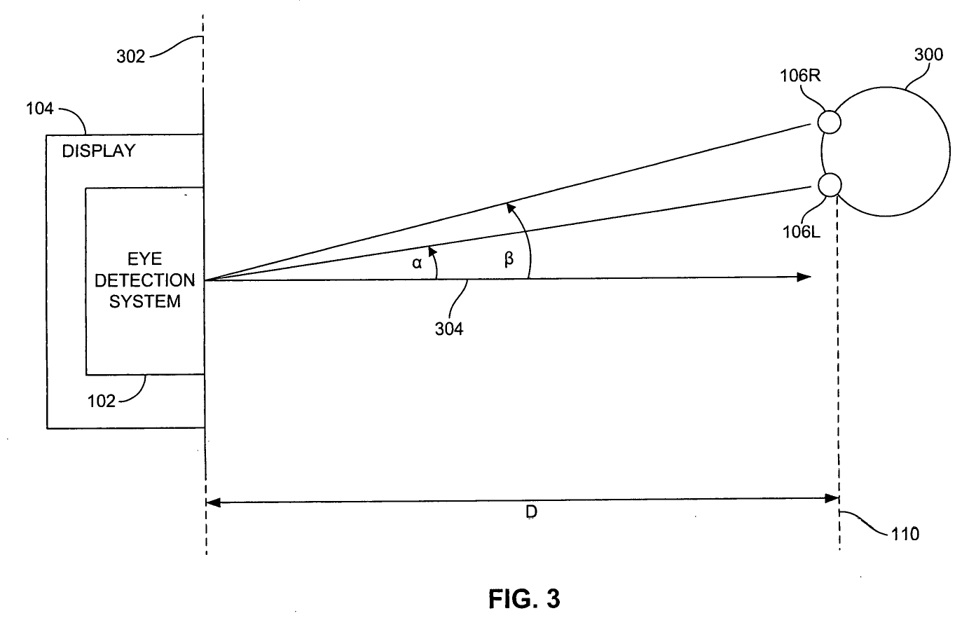

In operation of the autostereoscopic display system 100, a viewer positions himself or herself in a viewing plane 110 located at a distance D in front of the display 104, with the viewer being represented by the eyes 106L and 106R in FIG. 1. The eye detection system 102 determines several viewer eye parameters including an angle between the viewer's left eye 106L and a detection axis (not shown) extending parallel to the distance D and a second angle between the viewer's right eye 106R and the detection axis. These viewer eye parameters and the manner in which the eye detection system 102 determines these viewer eye parameters will be described in more detail below with reference to FIG. 3.

The eye detection system 102 provides the determined viewer eye parameters to the display control circuitry 108. The display control circuitry 108 controls the overall operation of the autostereoscopic display 104, including providing video data corresponding to the left and right images IL and IR being presented on the display and controlling the display to provide desired portions of this video data to the left and right eyes 106L and 106R of the viewer. In response to the viewer eye parameters, the display control circuitry 108 adjusts the video data and operation of the display 104 to provide the proper portions of the video data to the left and right eyes 106L and 106R of the viewer. In this way, the portion of the video data corresponding to the left image IL is provided to the left eye 106L of the viewer while the portion of the video data corresponding to the right image IR is provided to the right eye 106R of the viewer. The viewer perceives three-dimensional images due to the differences between the two images IL and IR as previously described and as will be understood by those skilled in the art.

By detecting parameters of the viewer's eyes 106L and 106R, the autostereoscopic display system 100 provides improved performance and viewer positioning flexibility. A viewer may be positioned anywhere within the viewing plane 110 and the eye detection system 102 and control circuitry 108 effectively operate in combination to steer the viewing window VW to the proper location. Also note that although a single viewing plane 110 is shown in FIG. 1 at a distance D from display 104, the location of this viewing plane from the display is variable. Based upon the detected parameters of the viewer's eyes 106L and 106R, namely the angles of the left and right eyes relative to the detection axis and the distance between the eyes, which may be determined from the difference between these angles, the control circuitry 108 adjusts operation of the display 104 to properly provide the images IL and IR to the left and right eyes of the viewer and thereby improve the viewer's perception of depth when viewing the display. For example, where a young child is viewing the display 104 the separation between the child's eyes 106L and 106R will be less than that of a typical adult. In such a situation, the eye detection system 102 determines the actual distance between the viewer's eyes 106L and 106R and thereby enables the control circuitry 108 to control the operation of the display to improve the perception of depth by the child.

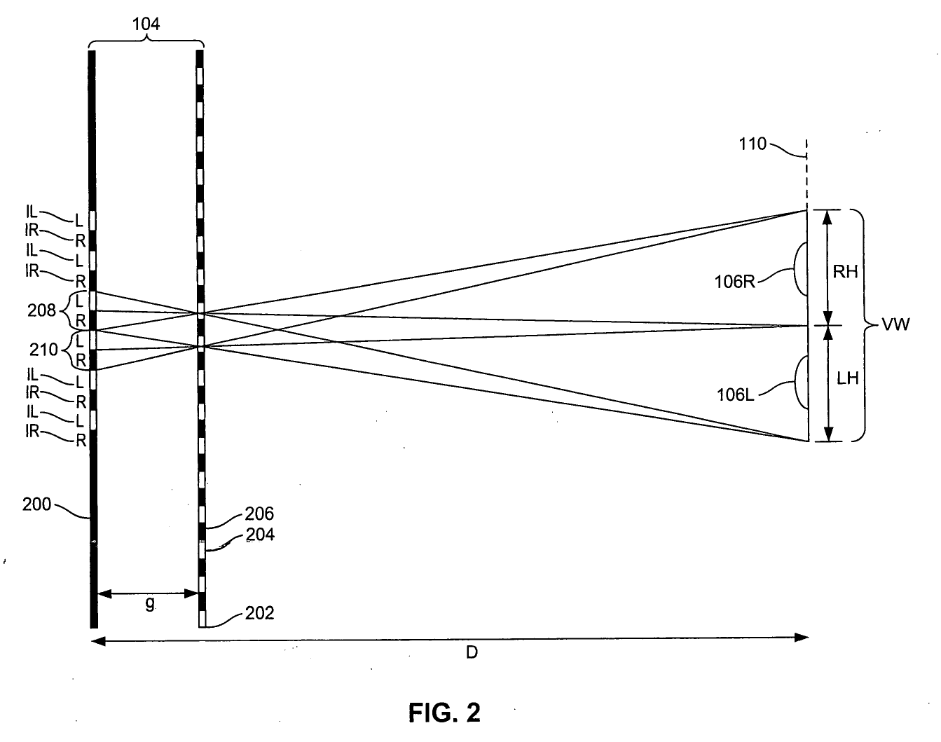

FIG. 2 is top view illustrating in more detail the operation of the parallax barrier display 104 of FIG. 1 in providing dual images IL and IR to the viewer's eyes 106L and 106R according to one embodiment of the present invention. The display 104 includes a display subsystem 200 such as a liquid crystal display (LCD) positioned at a distance g from and parallel to a parallax barrier 202. On the display subsystem 200, the left image IL and right image IR are displayed on alternating or interlaced columns of pixels. Several alternating columns of left and right pixels L and R are shown in FIG. 2, with the columns of left pixels L collectively corresponding to the left image IL and the columns of right pixels R collectively corresponding to the right image IR.

The parallax barrier 202 includes alternating vertical apertures 204 and vertical masks 206 positioned relative to the left and right columns of pixels L and R such that the left and right images IL and IR formed by these pixels are seen only by the viewer's left and right eyes 106L and 106R when positioned within the viewing window VW. FIG. 2 illustrates the illumination of left and right halves LH and RH of the viewing window VW for two sets 208 and 210 of adjacent left and right columns of pixels L and R. For the first set 208, dotted lines illustrate light from the corresponding left column of pixels L propagating through an aperture 204 positioned across from the set and illuminating the left half LH of the viewing window VW. Similarly, dotted lines illustrate light from the right column of pixels R in the set 208 propagating through the same aperture 204 and illuminating the right half RH of the viewing window VW. Solid lines illustrate the same thing for the second set 210 of left and right columns of pixels L and R, with the light from these columns propagating through the adjacent aperture 204 positioned across from these columns.

The control circuitry 108 of FIG. 1 controls the parallax barrier 202 as a function of the determined parameters of the viewer's eyes 106L and 106R to thereby steer the viewing window VW to the proper location. To do so the control circuitry 108 adjusts the positions of the apertures and masks 206 in the barrier 202 relative to the columns of pixels L and R. The particular way in which the control circuitry 108 adjusts the operation of the display 104 in response to the determined viewer eye parameters will vary depending upon the specific type of display. Where the display 104 includes the parallax barrier 202 the control circuitry 108 controls the barrier as a function of the determined viewer eye parameters as just described. Where the display 104 is another type of display, such as a dual LCD display as previously mentioned, the control circuitry 108 controls the display in a different way in response to the determined viewer eye parameters but to achieve the same result, namely to steer the viewing window VW to the viewer's eyes 106L and 106R.

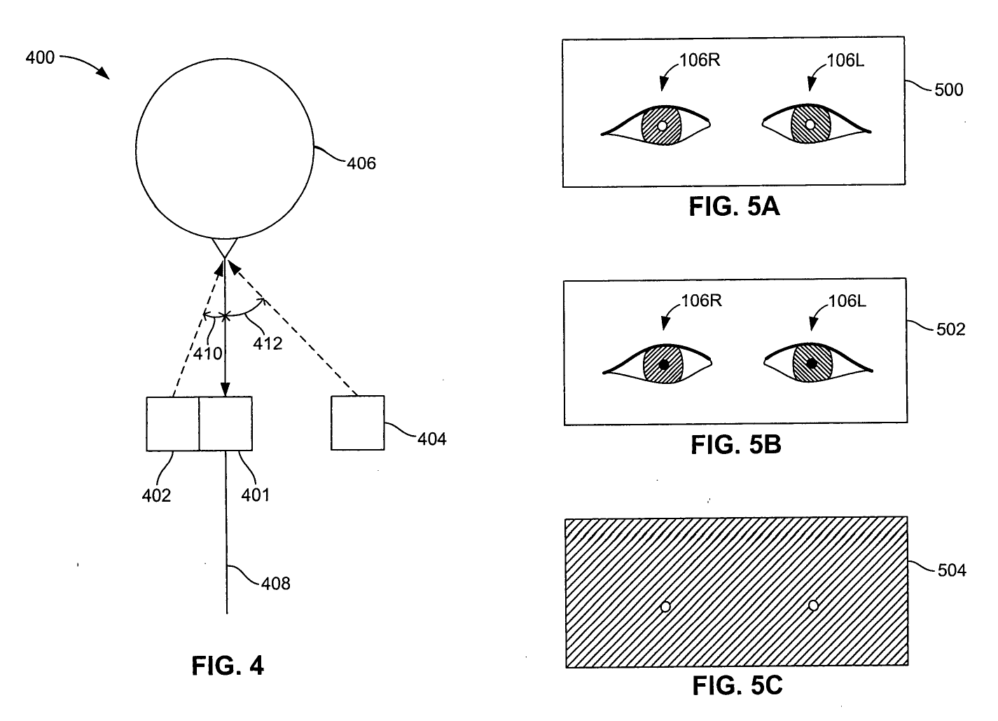

FIG. 3 is a top view illustrating in more detail the viewer eye parameters determined by the eye detection system 102 of FIG. 1 according to one embodiment of the present invention. The operation of the eye detection system 102 in determining these parameters is not discussed with reference to FIG. 3, but instead will be discussed in more detail with reference to FIGS. 4 and 5. In the embodiment of FIG. 3, the eye detection system 102 is shown positioned on top center of the display 104 although the detection system may be located in other positions in other embodiments of the present invention. A viewer's head 300 including the eyes 106L and 106R is shown positioned in the viewing plane 110 in front of the display 104. The eye detection system 102 determines three viewer eye parameters, which are important parameters for optimal control and operation of the display 104. The front of the display 104 and the front of the eye detection system 102 are defined as being contained in an image plane 302, and a detection axis 304 is defined as extending outward from the eye detection system normal to this image plane. The first parameter the eye detection system 102 determines is an angle α defined as the angle between the viewer's left eye 106L and the detection axis 304. The second parameter the eye detection system 102 determines is an angle β defined as the angle between the viewer's right eye 106R and the detection axis 304. The eye detection system 102 also determines a differential angle defined as the difference between the angles α and β (i.e. β-α), giving the control circuitry 108 (FIG. 1) detailed information about the spacing of the viewer's eyes 106L and 106R to enable proper adjustments of the display 104.

In another embodiment of the system 100, the eye detection system 102 also determines the distance D between the image plane 302 and the viewing plane 110. First, it should be noted that once the angles α and β are determined the distance D of the viewer is not important in that the viewer could be at any number of distances D defined by varying positions of the viewer along axes defined by the angles α and β. In some embodiments of the system 100, the control circuitry 108 may control segments of the display 104 differently as a function of where the viewer is positioned relative to each segment. A segment of the display 104 is group of vertical columns of pixels of the display. Thus, for example, a first segment may be defined to the left and right of the detection axis 304, a second segment defined by a group of vertical columns of pixels to the left of the first segment, a third segment defined by a group of vertical columns of pixels to the right of the first segment, and so on outward from the detection axis to the edges of the display 104. Also, in embodiments of the system 100 where the eye detection system 102 is not positioned in the center of the display 104, the eye detection system would need to determine the distance D of the viewer from the display 104, as will be appreciated by those skilled in the art.

FIG. 4 is a block diagram of a differential-angle illumination eye detection system 400 corresponding to one embodiment of the eye detection system 102 of FIG. 1. In operation, the differential-angle illumination eye detection system 400 including a detector that takes two images of a viewer's face to image the viewer's eyes. One of the images is taken using lighting that is close to or “on” the axis of the detector (“on-axis”), while the other image is taken using lighting that is at a larger angle to the detector (“off-axis”). Assuming the viewer's eyes are open, the difference between the images will highlight the pupils of the eyes because the somewhat diffuse reflection from the retinas is detected only in the on-axis image. In this way, the differential-angle illumination eye detection system 400 detects location of the viewer's eyes by detecting the locations of the viewer's pupils. The strong pupil signal in the on-axis case is known as “red-eye” in conventional flash photography. Other facial features of the viewer and environmental features surrounding the viewer are largely cancelled out due to use of the differential image, leaving the pupils as the dominant feature.

The differential-angle illumination eye detection system 400 includes an image detector 401, a first light source 402, and a second light source 404. The system 400 can optionally incorporate a controller or processor such as image processor (not shown), or instead it may be coupled to an external controller or processor. The drawings related to the system 400 should be understood as not being drawn to scale. For clarity of illustration, the first light source 402 and second light source 404 are shown as being on opposite sides of the detector 401 although in other embodiments these light sources are instead positioned on the same side of the detector.

One skilled in the art will understand that in the system 400, a key principle in obtaining differential reflectivity off the retinas of a viewer's eyes is the dependence of retinal reflectivity on the angle between the light sources 402 and 404 and the detector 401. This angle may be referred to as the “illumination angle” in the present description. Furthermore, the positions of the light sources 402 and 404 with respect to the image sensor are subject to additional conditions. To achieve successful differencing of the images resulting in spots corresponding to the reflecting retinas, it is desirable for the remainder of the field of view including the subject's face, apparel and interior of the vehicle to have significantly similar illumination profiles under the two different angles of illumination. The field of view is the area that is being illuminated by the light sources 402 and 404. For example, it is undesirable for illumination from the on-axis light source 402 to produce shadows that are significantly different than the shadows produced by the off-axis light source 404. With the above information in mind, it is recognized that placing first and second light sources 402 and 404 on the same side of detector 401 typically has advantages over placing the light sources on opposite sides of the detector 401. Once again, the light sources 402 and 404 are illustrated on opposite sides of the detector 401 merely for the sake of clarity.

In the system 400, the first light source 402 is situated at a first angle 410 from an axis 408 of the detector 401 while the second light source 404 is situated at a second angle 412 from the axis 408. The angle 412 is shown as greater than the angle 410, as would by definition of the sources 402 and 404 always be the case, but note that these angles are not drawn to scale. The angles 410 and 412 may be referred to as illumination angles. In general, a smaller first angle 410 increases the retinal return, where the term “retinal return” refers to the intensity such as the real photon count or equivalent that is reflected off the back of the viewer's eyes and back to the detector 401. The term “retinal return” is also used to include reflection off other tissue, etc., at the back of the eye other than or in addition to the retina. Accordingly, the first angle 410 is selected such that first light source 402 is on or close to the detector axis 408. In one embodiment, the first angle 410 is in the range of approximately zero to three degrees.

In general, the size of the second angle 412 is chosen so that only low retinal return from the second light source 404 will be detected at the detector 401. The iris, which is the colored area of the eye surrounding the pupil, blocks this retinal return and so it is important to consider pupil size under different lighting conditions when selecting the size of second angle 412. The second angle 412 is larger than first angle 410, but the second angle should not be too much larger than the first angle 410. This is true so that with the exception of the pupil, an image captured in the detector 401 using the second light source 404 will be similar to an image captured using the first light source 402. Accordingly, in one embodiment, the second angle 412 is in the range of approximately 3 to 15 degrees. The angles 410 and 412, or equivalently the positions of light sources 402 and 404, may be adjusted to suit, for example, the traits of a particular viewer. Thus, in one embodiment the angles of the light sources 402 and 404 may be adjusted in response to viewer traits. The first light source 402 is referred to as being on-axis since the first angle 410 is smaller than the second axis. Conversely, the second light source 404 is referred to as being off-axis due to the second angle 412 being larger than the first angle 410.

The operation of the eye detection system 400 will now be described in more detail with reference to FIGS. 5A-5C. In operation, the first light source 402 illuminates the field of view including the viewer 406 and the detector 401 captures a corresponding image from the incident light from the first light source that is reflected off the viewer and other objects in the field of view. FIG. 5A illustrates a sample image 500 captured by the detector 401 using the on-axis light source 402. The image 500 illustrates a bright pupil for each of the viewer's eyes 106L and 106R due to strong retinal returns from the retinas in these eyes.

The second light source 404 then illuminates the field of view including the viewer 406 and the detector 401 captures a corresponding image from the incident light from the second light source that is reflected off the viewer and other objects in the field of view. FIG. 5B illustrates an image 502 captured by the detector 401 using the off-axis light source 404. The image 502 may be taken at the same time as the image 500 of FIG. 5A or it may be taken in a frame immediately adjacent to the image 500 (e.g., 1/30th of a second ahead of or behind the image 500). The image 502 illustrates dark circles for the pupils of the viewer's eyes 106L and 106R due to the relatively weak retinal returns from the retinas in these eyes.

FIG. 5C illustrates an image 504 resulting from the difference between the images 500 and 502 generated using the on-axis and off-axis light sources 402 and 404. By taking the difference between the images 500 and 502 of FIGS. 5A and 5B, respectively, two relatively bright spots will remain against a relatively dark background. This is due to the difference in the retinal returns between images 500 and 502 while the remainder of each image is relatively the same in both images. There may be vestiges of other features of the eyes 106L and 106R remaining in the background of FIG. 504, but in general the bright spots of the two retinas will stand out in comparison to the relatively dark background. At this point, circuitry in the system 400 or in the control circuitry 108 of FIG. 1 processes this differential image 504 including the two bright spots corresponding to the viewer's retinas to thereby detect characteristics of the viewer's eyes 106L and 106R, such as location of the eyes and distance between the eyes.

In one embodiment of the system 400, the light sources 402 and 404 are formed from light-emitting diodes (LEDs), although other suitable light sources may be utilized in alternative embodiments. Each light source 402 and 404 may also be formed from a number of light-emitting devices such as LED, where each such device is located at substantially the same illumination angle. Additionally, some or all of the light-emitting devices in the sources 402 and 404 may be vertical cavity surface-emitting lasers (VCSELs), with suitable diffusers if needed to widen the angle of illumination. The detector 401, first light source 402, second light source 404, and axis 408 may be positioned in substantially the same plane or in different planes.

In one embodiment, the first light source 402 and the second light source 404 emit light that yields substantially equal image intensity (brightness) aside the areas corresponding to the retinas due to the different retinal returns. The light sources 402 and 404 may emit light of a different or of substantially the same wavelengths. The wavelength(s) and/or illumination intensities of light emitted by light sources 402 and 404 are selected so that the light will not distract the subject and so that the irises of the viewer's eyes will not contract in response to the light. The selected wavelength or wavelengths should be short enough for the detector 401 to properly respond (it is noted that imagers with thicker absorber regions tend to have better long wavelength response). In one embodiment, infrared or near-infrared wavelengths of light are generated by the light sources 402 and 404.

One embodiment of a differential-angle illumination eye detection system that may be used for the system 400 is disclosed in U.S. patent application Ser. No. 10/377,687 to Haven et al. filed on 28 Feb. 2003 and entitled APPARTUS AND METHOD FOR DETECTING PUPILS, which is incorporated herein by reference. Other embodiments of suitable differential-angle illumination eye detection systems are also disclosed in U.S. patent application Ser. No. 10/843,517 to Fouquet et al. filed on 10 May 2004 and entitled METHOD AND SYSTEM FOR WAVELENGTH-DEPENDENT IMAGING AND DETECTION USING A HYBRID FILTER and U.S. patent application Ser. No. 10/739,831 to ______ filed on 18 Dec. 2003, both of which are incorporated herein by reference.

The image detector 401 may be formed from any type of suitable imaging circuitry, such as a charge-coupled device (CCD) imager or a complementary metal-oxide semiconductor (CMOS) imager. In general, CMOS imagers are less expensive than CCD imagers and in some cases provide better sensitivity at infrared/near-infrared wavelengths than CCD imagers.

In FIG. 4 the viewer 406 is illustrated as directly facing the detector 401. The viewer 406 may, however, face in other directions relative to detector 401. The angle formed between the direction in which viewer 406 is looking and the axis 408 may be referred to as the gaze angle. The previously defined angles 410 and 412 do not change with gaze angle and the sensitivity of the retinal return to gaze angle is relatively weak. Therefore, the head and the eyes of the viewer 406 may frequently move relative to the detector 401 and the light sources 402 and 404 without significantly affecting the efficiency and reliability of the eye detection system 400. The detector 401 and light sources 402 and 404 provide satisfactory coverage of the field of view in front of the display 104 for varying distances D of the viewer from the display.

Recall, the eye detection system 400 also detects the distance D between the display and the viewer as previously discussed with reference to FIG. 3. The specific way the distance D is determined may vary, as will be appreciated by those skilled in the art. For example, in one embodiment the eye detection system 102 determines the distance D indirectly from the spacing of the viewer's eyes 106L and 106R as indicated by the differential angle β. Alternatively, the eye detection system 102 could include a stereoscopic detection system for determining the distance D.

In another embodiment of the eye detection system 102 of FIG. 1, the detection system operates under low levels of ambient light as described above to determine viewer eye position using differential-angle illumination to detect. When the level of ambient light is sufficiently high, the detection system 102 utilizes facial recognition techniques to locate the positions of the viewer's eyes. The control circuitry 108 controls the display 104 in response to the determined eye positions, whether determined through differential-angle illumination or facial recognition.

In another embodiment, the eye detection system 102 utilizes facial recognition techniques to identify the locations of a viewer's eyes. Such an embodiment may be used in an environment having sufficient levels of ambient light. As will be understood by those skilled in the art, facial recognition involves illuminating the viewer's face with light and from the reflected light detecting salient facial “landmarks” such as a person's eyes. Both the position of a person's eyes and the distance between the eyes are relatively constant among people and this fact is exploited by facial recognition algorithms. Many facial recognition algorithms locate a person's eyes first as part of face normalization and further localization of other facial landmarks. Eye detection allows facial recognition algorithms to focus on other salient facial features and to filter out noise to achieve facial recognition. This embodiment of the eye detection system 102 utilizes this eye detection component of facial recognition algorithms to identify the locations of viewer's eyes relative to the display 104 (FIG. 1). One skilled in the art will understand suitable facial recognition algorithms that may be implemented in the eye detection system 102 to detect a viewer's eye positions, and thus, for the sake of brevity, such algorithms will not be described herein in detail.

Although the eye detection system 102 has been described as determining viewer position by determining the angles α and β, one skilled in the art will appreciate that the detection system may detect the position of the viewer's eyes 106L and 106R relative to the display 104 in other ways. Thus, the eye detection system 102 determines the positions of the viewer's eyes 106L and 106R relative to the display 104 but the precise way in which the detection system does this may vary. For example, the eye detection system 102 may utilize a suitable equation, look-up table, or other process to determine the position of the viewer's eyes 106L and 106R in response to reflected light received by the detection system. With any of these methods, the eye detection system 102 is determining the position of the viewer's eyes 106L and 106R relative to the display 104 and may do so without expressly determining the angles α and β discussed for the embodiment of FIG. 1.

Even though various embodiments and advantages of the present invention have been set forth in the foregoing description, the above disclosure is illustrative only, and changes may be made in detail and yet remain within the broad principles of the present invention. Moreover, the functions performed by the control circuitry 108, detection system 102, display 104, and components of the system 400 may be combined to be performed by fewer elements, separated and performed by more elements, or combined into different functional blocks depending upon the actual components being utilized in a particular application, as will appreciated by those skilled in the art. Therefore, the present invention is to be limited only by the appended claims.

What is claimed is:

1. An autostereoscopic display system, comprising:
an autostereoscopic display subsystem operable to display stereoscopic images and to adjust characteristics of the displayed images responsive to detected viewer eye position parameters; and
an eye detection subsystem coupled to the display and operable to detect through differential-angle illumination the eye position of a viewer positioned in front of the display subsystem and to generate corresponding viewer eye position parameters, and the eye detection subsystem operable to apply the detected viewer eye position parameters to the display subsystem.

2. The autostereoscopic display system of claim 1 wherein the eye detection system further comprises:
a first detector for receiving reflected light;
a first light source for emitting first light at a first illumination angle relative to the axis of the first detector; and
a second light source for emitting second light at a second illumination angle relative to the axis, the second illumination angle greater than the first illumination angle, the first light and the second light having substantially equal intensity;
wherein pupils of a viewer's eyes are detectable using the difference between reflected first light and reflected second light received at the first detector.

3. The autostereoscopic display system of claim 2 wherein the first and second light sources are alternately activated.

4. The autostereoscopic display system of claim 3 wherein the first detector captures reflected first light and reflected second light in consecutive frames, wherein the difference is determined from pairs of consecutive frames.

5. The autostereoscopic display system of claim 2 wherein the first light and the second light have wavelengths that are different, wherein the first and second light sources are activated substantially at a same time.

6. The autostereoscopic display system of claim 5 wherein reflected first light and reflected second light are captured in a single image.

7. The autostereoscopic display system of claim 1 wherein the first and second lights are infrared or near-infrared lights.

8. The autostereoscopic display system of claim 1 wherein the display subsystem comprises a parallax barrier autostereoscopic display subsystem.

9. An autostereoscopic display system, comprising:
an autostereoscopic display subsystem operable to display stereoscopic images and to adjust characteristics of the displayed images responsive to detected viewer eye position parameters; and
an eye detection subsystem coupled to the display and operable to detect through a facial-recognition algorithm the eye position of a viewer positioned in front of the display subsystem and to generate corresponding viewer eye position parameters, and the eye detection subsystem operable to apply the detected viewer eye position parameters the display subsystem.

10. The autostereoscopic display system of claim 9 wherein the display subsystem comprises a parallax barrier autostereoscopic display subsystem.

11. The autostereoscopic display system of claim 10 wherein the eye detection subsystem is positioned on the top and in the center of the parallax barrier autostereoscopic display subsystem.

12. A method of controlling an autostereoscopic display, comprising:
emitting first light at a first illumination angle relative to a detection axis;
emitting second light at a second illumination angle relative to the detection axis, the second illumination angle being greater than the first illumination angle;
receiving reflected first and second light; and
determining from the received reflected first and second light the location of the eyes of a viewer positioned in front of the display; and
controlling the autostereoscopic display responsive to the determined location of the eyes of the viewer.

13. The method of claim 12 wherein the first light and the second light having substantially equal brightness.

14. The method claim 12 wherein receiving reflected first and second light comprises receiving the reflected light at an imaging plane of the display that is perpendicular to the detection axis.

15. The method of claim 12 wherein determining from the received reflected first and second light the location of the eyes of a viewer positioned in front of the display includes,
determining an angle of a first one of the viewer's eyes relative to the detection axis,
determining an angle of a second one of the viewer's eyes relative to the detection axis, and
determining a differential angle defined by the magnitude of the difference between the angles of the viewer's eyes.

16. The method of claim 12 wherein the first reflected light and the second reflected light are alternately received in response to the first and second light being alternately emitted, respectively.

17. The method of claim 12 wherein receiving reflected first and second light comprises simultaneously receiving the first reflected light and second reflected light.

18. A method of controlling an autostereoscopic display, comprising:
illuminating the face of a viewer positioned in front of the display;
applying a facial recognition algorithm to an image or images corresponding to light reflected off the viewers face in response to illuminating the face of the viewer;
determining the location of the viewer's eyes relative to the display through the application of the facial recognition algorithm; and
controlling the autostereoscopic display responsive to the determined location of the eyes of the viewer.

19. The method of claim 18 wherein controlling the autostereoscopic display comprises controlling characteristics of a parallax barrier in the display.

20. The method of claim 18 wherein determining the location of the viewer's eyes relative to the display through the application of the facial recognition algorithm includes determining an orthogonal distance of the viewer from a viewing plane of the display.
